(19) United States
(12) Patent Application Publication
(10) Pub. No.: US 2026/0112826 A1
(43) Pub. Date: Apr. 23, 2026

(54) CONDUCTOR CONNECTION TERMINAL AND ELECTRICAL PLUG CONNECTOR

(71) Applicant: WAGO Verwaltungsgesellschaft mbH, Minden (DE)

(72) Inventors: Joel PALTEN, Bad Oeynhausen (DE); Henning MEIER, Bueckeburg (DE)

(73) Assignee: WAGO Verwaltungsgesellschaft mbH, Minden (DE)

(21) Appl. No.: 19/361,485

(22) Filed: Oct. 17, 2025

(30) Foreign Application Priority Data
Oct. 18, 2024 (DE) 20 2024 105 988.3

(51) Int. Cl. H01R 9/22; H01R 4/48; H01R 9/24; H01R 9/26

(52) U.S. Cl. CPC H01R 9/223; H01R 4/4833; H01R 9/2491; H01R 9/2616

(57) ABSTRACT

A connection terminal with a housing, and multiple conductor clamping connections to which at least one electrical conductor is connectable in each case to a clamping point by means of elastic force. The conductor clamping connections are arranged in the housing in a circular shape around a center. The conductor connection terminal has a sliding actuating element with a manual actuating surface for manually actuating multiple or all conductor clamping connections and/or the electrical conductor. The housing may be designed as an insulation material housing. An electrical plug connector, in particular a circular plug connector, having at least one such conductor connection terminal is also provided.

This nonprovisional application claims priority under 35 U.S.C. § 119(a) to German Patent Application No. 20 2024 105 988.3, which was filed in Germany on Oct. 18, 2024, and which is herein incorporated by reference.

### BACKGROUND OF THE INVENTION

### Field of the Invention

The invention relates to a conductor connection terminal with a housing, and multiple conductor clamping connections to which at least one electrical conductor is connectable in each case to a clamping point by means of elastic force, wherein the conductor clamping connections are arranged in the housing in a circular shape around a center, wherein the conductor connection terminal has a sliding actuating element with a manual actuating surface for manually actuating multiple or all conductor clamping connections and/or the electrical conductor. The housing may be designed as an insulation material housing. The invention further relates to an electrical plug connector, in particular a circular plug connector, having at least one such conductor connection terminal.

### Description of the Background Art

A generic conductor connection terminal and a plug connector are known from DE 20 2021 101 354 U1, which corresponds to US 2022/0302607, which is herein incorporated by reference.

### SUMMARY OF THE INVENTION

It is therefore an object of the present invention to further improve a conductor connection terminal and a plug connector.

This object is achieved in an example, in that the sliding actuating element can be supported so that it is displaceable in the housing in a longitudinal displacement direction, and/or the manual actuating surface of the sliding actuating element is situated in a central area of the conductor connection terminal that is present between the conductor clamping connections. The invention allows a compact design of the conductor connection terminal, since a plurality of conductor clamping connections may be fitted in the circular shape in a space-saving manner, for example by arranging the conductor clamping connections on a circular path in the housing. The conductor clamping connections are preferably uniformly distributed on a circular path. The central area is situated in a plane between the conductor clamping connections, viewed perpendicularly to the displacement direction, so that the manual actuating surface does not have to be situated directly between the conductor clamping connections in all operating states. The housing in principle may have any desired outer contour. The housing advantageously has a design as a circular housing, for example with a cylindrical shape, whose longitudinal direction is aligned with the longitudinal displacement direction of the sliding actuating element.

Such a sliding actuating element enables simple and ergonomically favorable actuation of multiple or all conductor clamping connections of the conductor connection terminal and/or the electrical conductors. In addition, such a sliding actuating element may be structurally integrated into the conductor connection terminal in a satisfactory manner, in particular in the form of a central interior sliding actuating element, for example a push actuator. In contrast to a rotary actuating element or a swivelable lever, for the sliding actuating element the necessary actuating movement of the conductor connection terminals is achieved solely by the displacement movement in the longitudinal displacement direction. When the sliding actuating element is actuated at the manual actuating surface, it is moved, for example, against an elastic force from a starting position into an actuated position. The particular conductor connection terminals and/or electrical conductors are actuated by this displacement of the sliding actuating element.

The conductor clamping connections may be selectively formed, for example, as a spring-loaded clamping connection, each with a clamping spring, or as an insulation displacement connection, optionally also combined with one another as explained below. In the case of the design of a conductor clamping connection as a spring-loaded clamping connection, the clamping spring may be deflected into an open position by the sliding actuating element, for example by deflecting a clamping leg of the clamping spring. When a conductor clamping connection is designed as an insulation displacement connection, a relative movement between the electrical conductor to be connected and the associated insulation displacement connection may be brought about by the sliding actuating element, by clamping the electrical conductor in the cutting gap at the clamping point. Depending on the design of the conductor connection terminal, the sliding actuating element may be used to move only the electrical conductor or only the insulation displacement connection, or a movement of both of these elements may be brought about.

As mentioned, the manual actuating surface of the sliding actuating element may be situated in a central area of the conductor connection terminal that is present between the conductor clamping connections. In particular, at least a portion of the sliding actuating element may be situated between the conductor clamping connections. The actuating surface of the sliding actuating element may also be situated between the conductor clamping connections, at least in at least one actuation state of the sliding actuating element.

The longitudinal displacement direction of the sliding actuating element can extend orthogonally to a plane defined by the circular shape of the conductor clamping connections. This allows reliable actuation of the multiple conductor clamping connections by the one sliding actuating element, and at the same time allows simple implementation of the actuation mechanism. The longitudinal displacement direction may extend, for example, as a longitudinal axis of the conductor connection terminal, centrally through the ring-shaped arrangement of the conductor clamping connections. For the electrical conductors to be inserted, the conductor connection terminal may in each case define a conductor insertion direction that is specified by features of the housing, for example, in which the electrical conductor is to be inserted into the particular conductor clamping connection or into the housing. The conductor insertion directions of one, multiple, or all conductor clamping connections may extend in parallel to the longitudinal displacement direction of the sliding actuating element.

By actuating the sliding actuating element at the manual actuating surface, the clamping points of conductor clamping connections may be opened, and/or a particular electrical conductor may be connected to the conductor clamping connections. The sliding actuating element thus carries out the necessary actuating movements at the conductor clamping connections or the electrical conductors, so that ultimately an electrical conductor may be connected to the associated clamping connection.

Further, by actuating the sliding actuating element at the manual actuating surface, the particular conductor clamping connections and/or electrical conductors may be acted on with an actuating force in a radial direction and/or in an axial direction with respect to the circular shape of the conductor clamping connections. This allows the electrical conductors to be connected to a particular conductor clamping connection using a less complicated, easily implemented, compact actuation mechanism. In the case of the radial direction, this may be in the radial inwardly pointing direction or the radially outwardly pointing direction, for example. In the case of the axial direction, this direction may be parallel to the longitudinal displacement direction of the sliding actuating element.

The sliding actuating element can be nonrotatably supported in the housing. This ensures that the conductor clamping connections are always actuated at the positions of the sliding actuating element that are intended for this purpose. In addition, rotation and/or tilting of the sliding actuating element during the displacement movement are/is avoided. The sliding actuating element is in particular nonrotatably supported about its longitudinal axis that is formed by the longitudinal displacement direction.

A conductor insertion opening for inserting an electrical conductor to be connected to the conductor clamping connection can be associated with each conductor clamping connection. This allows the user to easily, reliably associate the electrical conductors to be connected with the particular conductor clamping connection. The conductor insertion openings may all be situated at the same side of the housing of the conductor connection terminal, i.e., at a conductor insertion side of the housing.

At least one actuating contour and/or at least one actuating element for actuating the particular conductor clamping connection and/or electrical conductor can be situated at a radial outer surface of the sliding actuating element. The actuating forces during a displacement movement of the sliding actuating element may thus be satisfactorily transferred to the conductor clamping connections or the electrical conductors. For example, one actuating contour and/or one actuating element are/is associated with a conductor clamping connection, and vice versa.

The actuating contour can be designed as a ramp-shaped outer contour with at least one elevation and/or depression. This allows reliable and uniform actuation of the conductor clamping connections.

The sliding actuating element may have an outer contour, extending in parallel to the longitudinal displacement direction, at a radial outer surface situated behind the ramp-shaped outer contour in the longitudinal displacement direction. This has the advantage that in the actuated state, i.e., when the conductor clamping connections are in an open position, for example, the sliding actuating element is held in this actuated position by the forces of the conductor clamping connections, and does not have to held in the actuated position by the user.

One, multiple, or all conductor clamping connections can be designed as spring-loaded clamping connections, each having at least one clamping spring and a busbar which is associated with the clamping spring, and which with the clamping spring forms a clamping point for connecting an electrical conductor. In this way, the conductor clamping connections may be formed using proven clamping spring connection technology. The clamping spring may be designed, for example, as a cage clamp spring, a leg spring, or some other type of clamping spring, in particular as a V-shaped clamping spring or as a loop-shaped clamping spring. The electrical conductor is then clamped, for example, between a clamping leg of the clamping spring and the busbar.

One, multiple, or all clamping springs can have at least one clamping leg, a spring bend that adjoins the clamping leg, and a contact leg that adjoins the spring bend. At a side facing the busbar or the clamping point, the clamping leg may have a clamping edge via which the electrical conductor may be clamped. The contact leg is used to support and fix the clamping spring. The clamping spring is supported against the elastic force of the clamping leg, for example at the busbar or at some other component of the conductor connection terminal, via the contact leg.

The particular spring bend and/or the particular clamping leg can protrude radially inwardly beyond the respective associated busbar. This allows simple actuation of the particular clamping spring by the sliding actuating element, for example by the actuating contour or the actuating element, as explained above, being brought into contact with the spring bend and/or the clamping leg and thus deflecting the clamping leg.

The clamping legs of the clamping springs may be movable into an open position by actuating the sliding actuating element at the manual actuating surface. In the open position, at least the clamping edge of the clamping leg is swiveled away from a contact section of the busbar. The clamping leg may be swiveled, for example between an open position in which the electrical conductor is freely movable between the clamping leg and the contact section, and a clamped position in which the clamping leg connects the electrical conductor to the contact section.

For one, multiple, or all clamping springs the conductor connection terminal can have a retaining element in each case which is configured to hold the clamping leg of the particular clamping spring in the open position. By means of the retaining element, the clamping leg can be held in the open position even when the sliding actuating element exerts no actuating force on the spring bend and/or the clamping leg. Such a design allows integration of automatic release technology into conductor connection terminals having various constructions. In particular, proven conductor connection terminals having a known construction may thus be developed with little complexity to provide an automatic release functionality, i.e., with an automatic conductor connection of the electrical conductor to be connected, in which the clamping leg is held in the open position by the retaining element, and may be automatically released when the electrical conductor is inserted. By insertion of the electrical conductor, clamping of the electrical conductor may thus be brought about by releasing the fixing of the clamping leg to the retaining element.

The retaining element may be situated so that it is movable, for example displaceable, swivelable, or deflectable in some other way, so that it may be easily deflected by the inserted conductor in order to bring about the desired release effect of the clamping leg from the retaining element. The retaining element may, for example, be displaceably supported, for example displaceable in a linear direction or an arced direction. The retaining element may be swivelably supported. In this case, the retaining element may be swiveled about a fixed or variable swivel axis. In the case of a variable swivel axis, the retaining element may be swivelably supported in a floating manner, for example. The retaining element may also undergo a combined displacement and swivel movement. The retaining element may also be movably supported in some other way so that it is deflectable far enough to release the latch of the clamping leg on the retaining element.

The retaining element is in particular a component, independent from the sliding actuating element, to which the clamping leg may be fixed when it has previously been moved by the sliding actuating element, for example, into the open position. The clamping leg is then held in the open position by the retaining element, even when the sliding actuating element is released or is returned to the original unactuated position.

All clamping points may advantageously be opened at the same time by means of the one sliding actuating element, and the clamping springs may be held in an open position at the particular retaining element. The connections could then be established individually in succession by inserting the electrical conductors. For this purpose, it is advantageous when the sliding actuating element is returned to its original unactuated position, for example by a restoring element such as a restoring spring that is separate or integrated into the sliding actuating element. To connect the conductors, it is then not necessary for all conductors to be simultaneously held in a connection position.

The retaining element may act directly on the clamping leg, for example, to hold it in the open position. Thus, for example, a first detent element may be situated at the clamping leg and a second detent element may be situated at the retaining element, with the first and second detent elements in the open position being latchable to one another. The first detent element may be designed as a detent projection or detent hook. The second detent element may be designed as a detent edge or detent opening.

For one, multiple, or all of the retaining elements the conductor connection terminal can have a release element that is associated with the retaining element and that has a release section by means of which the clamping leg that is held in the open position at the retaining element is releasable from the retaining element when an electrical conductor to be connected exerts an actuating force on the release section. This allows the clamping leg to be automatically released from the retaining element by inserting the electrical conductor. The release section may be acted on with pressure force by a separate tool, a component of the conductor connection terminal such as an actuating element, or directly via an inserted electrical conductor itself, thus bringing about the release of the clamping leg from the retaining element. By use of the release element, the clamping leg that is held in the open position at the retaining element is releasable from the retaining element by exerting pressure on the release section in the conductor insertion direction of the electrical conductor to be connected. Depending on the construction of the spring-loaded clamping connection, the release element may be designed as part of the clamping spring, for example as a release element that is formed in one piece with the clamping spring, or as a separate component.

The release section of the release element may be situated behind the clamping point in the conductor insertion direction.

The retaining element may be designed as a separate component that is fastened, for example, to an insulation material housing of a conductor connection terminal, to the busbar, or to some other part.

For one, multiple, or all clamping springs, the retaining element associated with the clamping spring and/or the release element can be formed in one piece with the clamping spring. This allows particularly efficient and economical manufacture of the components of the conductor connection terminal as well as simple installation in the housing. The clamping spring with the retaining element and/or release element thus formed in one piece may be manufactured as a stamped/bent part, for example.

One, multiple, or all conductor clamping connections can be designed as insulation displacement connections, each having oppositely situated cutting edges between which a cutting gap is formed which establishes a clamping point for clamping an electrical conductor. The insulation displacement connections are thus arranged in a ring shape in the housing. This allows particularly space-saving accommodation of multiple insulation displacement connections in the housing, which is particularly well suited for circular plug connectors.

Such an insulation displacement connection, which may also be referred to as an IDC, is configured to make direct electrical contact with an electrical conductor, provided with insulation sheathing, without prior stripping of the wire. This takes place by pressing the electrical conductor together with its insulation sheathing into the cutting gap through the oppositely situated cutting edges, which cut the insulation and establish electrical contact with the internal conductor. The cutting edges may have a forked design, for example.

Due to the insulation displacement connections, the conductor connection terminal according to the invention allows simple and quick connection of multiple electrical conductors to the insulation displacement connections without prior stripping of the wire. The electrical conductors together with their insulation may be inserted into the housing and then directly electrically contacted via insulation displacement technology. Thus, for example, all electrical conductors to be connected may be inserted next to one another from the same side of the housing and electrically contacted. The electrical conductors therefore require no further preliminary treatment, in particular no additional cutting or trimming. The conductor connection terminal may thus be fitted with the electrical conductors in a particularly quick and easy manner, in particular without having to bend each electrical conductor and individually insert it in succession into the respective insulation displacement connection.

The cutting gaps of multiple or all insulation displacement connections can be oriented with regard to their longitudinal direction of extension in the radial direction, in particular in the radial inwardly pointing direction or the radially outwardly pointing direction, and/or in the axial direction with respect to the circular shape in which the insulation displacement connections are situated in the housing. Accordingly, a relative movement between the electrical conductor and the insulation displacement connection in the mentioned radial and/or axial direction with respect to the circular shape is necessary for clamping an electrical conductor to the insulation displacement connection. This allows contacting of a plurality of electrical conductors to insulation displacement connections, and at the same time, a simpler design of a multipole conductor connection terminal.

The object stated at the outset is further achieved by an electrical plug connector, in particular a circular plug connector, having at least one conductor connection terminal of the type explained above. The advantages explained above may also be achieved by this electrical plug connector.

Further scope of applicability of the present invention will become apparent from the detailed description given hereinafter. However, it should be understood that the detailed description and specific examples, while indicating preferred embodiments of the invention, are given by way of illustration only, since various changes, combinations and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor connection terminal in a perspective partial view in the unactuated state,

FIG. 2 shows the conductor connection terminal according to FIG. 1 in the actuated state,

FIG. 3 shows the conductor connection terminal according to FIG. 1 in the longitudinal section,

FIG. 4 shows the conductor connection terminal according to FIG. 2 in the longitudinal section,

FIG. 5 shows a further example of a conductor connection terminal in the longitudinal section in the unactuated state,

FIG. 6 shows the conductor connection terminal according to FIG. 5 in the actuated state,

FIG. 7 shows a further example of a conductor connection terminal in the longitudinal section in the unactuated state,

FIG. 8 shows the conductor connection terminal according to FIG. 7 in the actuated state,

FIG. 9 shows a clamping spring in a perspective view, and

FIG. 10 shows an insulation displacement connection in a perspective view.

### DETAILED DESCRIPTION

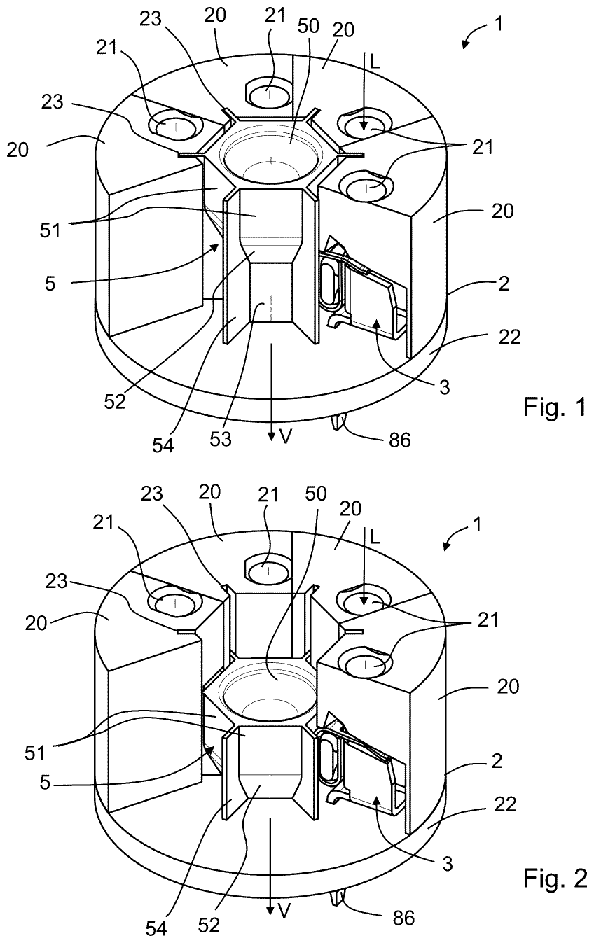

The conductor connection terminal 1 illustrated in FIG. 1 has a housing 2 that may be designed as an essentially cylindrical circular housing, for example. A portion of the housing 2 is divided into multiple housing sections 20 having a circular segment-like shape, for example. A conductor clamping connection 3 is situated in each housing section 20. The conductor clamping connections 3 are arranged in a circular shape around a center. In addition, a conductor insertion opening 21 for inserting an electrical conductor into the housing 2 is formed in each housing section 20 on a conductor insertion side of the housing 2. An electrical conductor may be inserted through the conductor insertion opening 21 in a conductor insertion direction L to the conductor clamping connection 3 situated in the housing 2. The housing sections 20 are closed off by a closing element 22, for example a plate, on a side of the housing facing away from the conductor insertion side. Connection contacts 86 extend through the closing element 22, with each connection contact 86 being electrically connected to a conductor clamping connection 3.

FIGS. 1 and 2 show the conductor connection terminal 1 in an incomplete form in which the housing sections 20 symmetrically situated in a ring shape are only partially illustrated, in that the front two housing sections 20 are omitted. This allows a view of a sliding actuating element 5 that is situated centrally between the conductor clamping connections 3, and whose function is better explained by this type of illustration. In the completed state of the conductor connection terminal 1, however, the sliding actuating element 5 is completely circularly surrounded by the housing sections 20 and the conductor clamping connections 3 situated therein.

As is apparent, the conductor clamping connections 3 are situated in a circular shape around the sliding actuating element 5. In particular, a manual actuating surface 50 that is used to manually actuate the sliding actuating element 5 in a longitudinal displacement direction V with the aid of an actuation tool such as a screwdriver, for example, is situated in a central area of the housing 2 between the conductor clamping connections 3. By manual exertion of a pressure force on the manual actuating surface 50, the sliding actuating element 5 may be moved in the longitudinal displacement direction V, as shown in FIG. 2. In the process, the conductor clamping connections 3 are actuated, as explained in greater detail below with reference to the further illustrations.

In FIG. 1 the conductor connection terminal 1 is illustrated with an unactuated sliding actuating element 5; i.e., the sliding actuating element 5 is in a starting position. In FIG. 2 the sliding actuating element 5 is illustrated in the actuated state, in that it is moved downwardly in the longitudinal displacement direction V. It is apparent that for each conductor clamping connection 3, the sliding actuating element 5 on the radial outer side has a respective actuating contour 51, 52, 53 via which the conductor clamping connection 3 associated with the respective actuating contour 51, 52, 53 may be actuated. Starting from the side facing the manual actuating surface 50, the actuating contour 51, 52, 53 extends with a first section 51 that is parallel to the longitudinal displacement direction V. The first section 51 is adjoined by a second section 52 that extends at an angle to the longitudinal displacement direction V in a ramp-like manner. The second section 52 is adjoined by a third section 53 which in turn extends in parallel to the longitudinal displacement direction V. Between the actuating contours 51, 52, 53 associated with the respective conductor clamping connections 3, the sliding actuating element 5 has guide tabs 54 that protrude in a star-shaped pattern, by means of which the sliding actuating element 5 is guided in the longitudinal displacement direction V into slotted receptacles 23 of the housing 2. In addition, the guide tabs 54 and the slotted receptacles 23 prevent undesirable rotation of the actuating element 5 about its longitudinal axis.

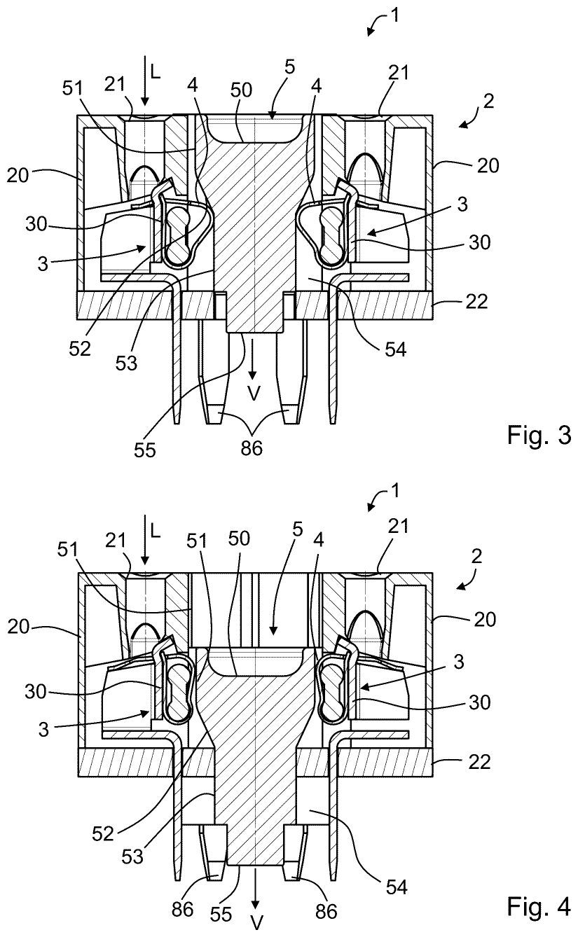

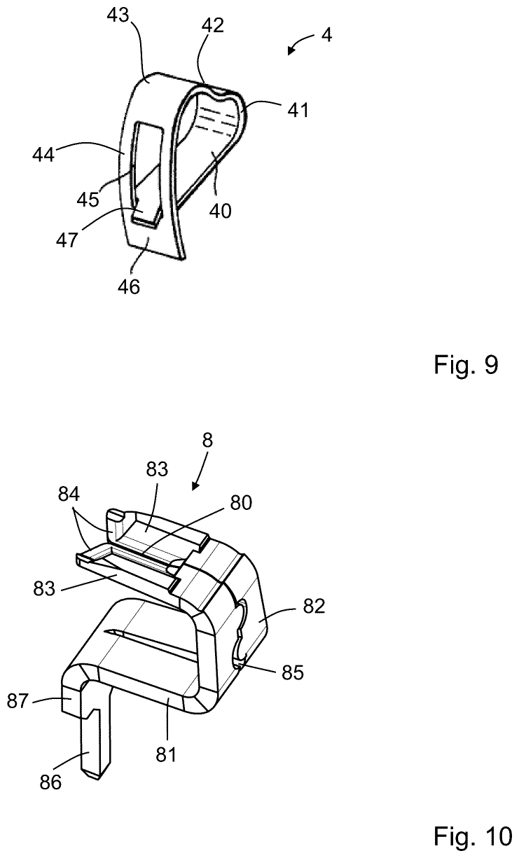

In the examples described below with reference to FIGS. 3 through 8, the conductor clamping connections 3 are designed in each case as spring-loaded clamping connections, each having a clamping spring 4 and a busbar 30. The clamping spring 4 may be designed as a cage clamp spring, for example, as illustrated, or as a clamping spring that is formed in some other way. As an example, it is first explained how a clamping spring 4 designed as a cage clamp spring is constructed, as illustrated in FIG. 9.

The clamping spring 4 according to FIG. 9 has a clamping leg 44 that is adjoined by a spring bend 43. A contact leg 40 may adjoin the spring bend 43, either directly or via further elements 41, 42. For example, the contact leg 40 may be connected to the spring bend 43 via an arched section 41 and a connecting section 42. The contact leg 40 is used to support the clamping spring on the busbar 30, for example, as is apparent in FIG. 3.

The clamping spring 4 has a window-like opening 45 in the clamping leg 44 which is closed off toward the free end of the clamping leg 44 by a clamping section 46. The contact leg 40 extends with a tongue 47 through the window-like opening. In turn, the busbar 30 then likewise protrudes through the window-like opening 45 in the area between the tongue 47 and the clamping section 46, as is apparent in FIG. 3. The clamping point for the electrical conductor is then formed inside the window-like opening 45, between the side of the busbar 30 pointing toward the clamping section 46 and a clamping edge of the clamping section 46 pointing toward the busbar 30.

As also shown in FIG. 3, from each conductor clamping connection 3 a connection contact 86 may be guided through the closing element 22 and may protrude from the housing 2. The connection contacts 86 may be designed as solder connections for soldering into a circuit board, as plug connections for inserting an associated plug connector as a mating piece, or as some other electrical connections. If the connection contacts 86 are designed as plug connections, the conductor connection terminal 1 may thus at the same time be designed as a plug connector, in particular a circular plug connector.

In FIG. 3 the conductor connection terminal 1 is once again illustrated in the unactuated state, as in FIG. 1. Accordingly, the clamping legs 44 of the clamping springs 4 are not yet deflected by the sliding actuating element 5. If the sliding actuating element 5 is now moved in the longitudinal displacement direction V, the ramp-shaped second sections 52 cause the clamping leg 44 to deflect in a radially outwardly pointing direction, as shown in FIG. 4. As likewise shown in FIG. 4, if the sliding actuating element 5 is then in a position in which the first section 51 rests against the particular clamping spring 4, no restoring forces on the sliding actuating element 5 are generated by the clamping springs 4, so that the sliding actuating element 5 remains in this actuated position, even without manual actuation. The clamping points are now opened so that an electrical conductor can be placed there without effort. When the sliding actuating element 5 is moved back into the original starting position, as illustrated in FIG. 3, the clamping springs 4 spring back and clamp the respective electrical conductor to the clamping point. A return movement of the sliding actuating element 5 may be brought about, for example, by manually pressing on a surface 55 of the sliding actuating element 5 opposite from the manual actuating surface 50.

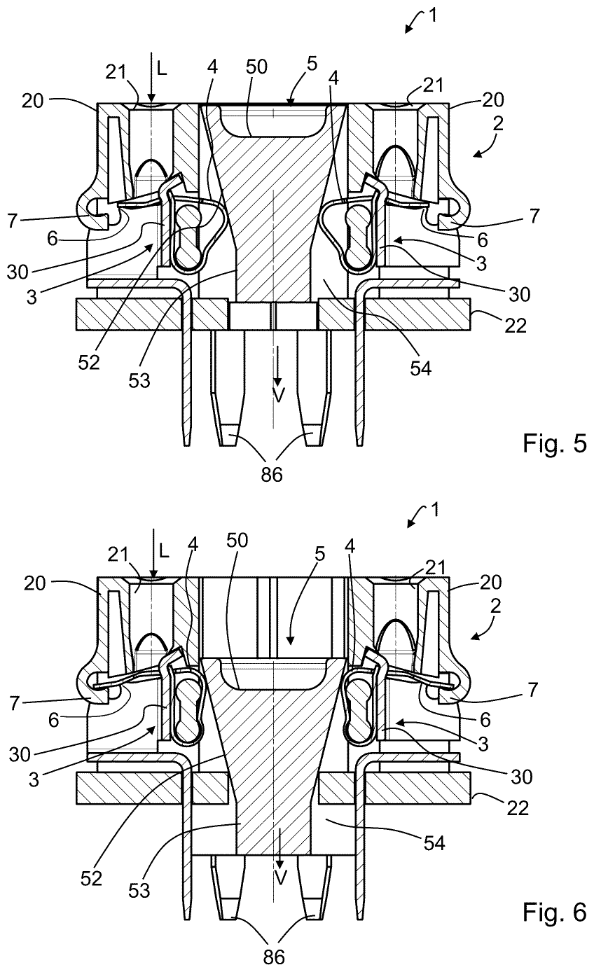

With reference to FIGS. 5 and 6, an example of the conductor connection terminal 1 is explained, which for each conductor clamping connection 3 has a retaining element 6 for holding the clamping leg 44 in the open position. As is apparent, in this case the sliding actuating element 5 may be designed without the first section 51 of the actuating contour 51, 52, 53; i.e., the second, ramp-shaped section 52 may extend further upwardly to the area of the actuating surface 50.

The retaining element 6 associated with a respective clamping spring 4 may be designed, for example, as a detent element, for example by the retaining element 6 being situated at the busbar 30 or being formed in one piece with same, or being situated at some other part of the conductor connection terminal, for example at the housing 2. FIG. 5 once again shows the conductor connection terminal 1 in the unactuated state. In FIG. 6 the conductor connection terminal 1 has been actuated by the sliding actuating element 5. The clamping legs 44 of the clamping springs 4 are now held at their respective associated retaining elements 6. In this state, the sliding actuating element 5 experiences essentially no load from forces of the clamping springs 4.

For releasing the latching of the clamping leg 44 to the particular retaining element 6, the conductor connection terminal 1 may have one or more release elements 7, for example release elements 7 that are to be manually actuated. The conductor connection terminal 1 may have a release element 7 for each conductor clamping connection 3. Fewer release elements 7 may also be present, in which case each release element may be configured to release multiple clamping legs 44. By manual action on the release element 7, for example by pressing radially inwardly, the latching of the clamping leg 44 to the retaining element 6 may be discontinued. As a result, the clamping spring 4 springs back so that a previously inserted electrical conductor may be clamped.

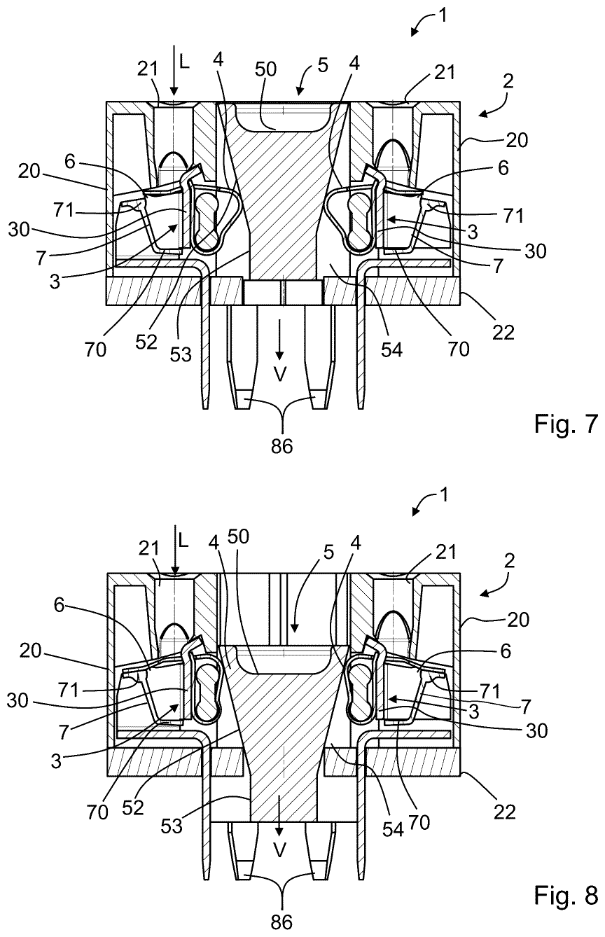

FIGS. 7 and 8 show an example of the conductor connection terminal 1 in which, as previously explained with reference to FIGS. 5 and 6, respective retaining elements 6 for holding a particular clamping leg 6 in the open position are present. These retaining elements 6 may be designed as explained above. The conductor connection terminal 1 according to FIGS. 7 and 8 is designed with an automatic conductor connection in such a way that for each conductor clamping connection 3, an automatic release element 7 having a release section 70 and an actuation section 71 is present. This release section 70 is placed in such a way that it can be acted on by force by the inserted electrical conductor. Due to this action of force on the release section 70 by the electrical conductor, the actuation section 71 of the release element 7 is automatically actuated, by means of which a release force is transferred to the clamping leg 44 in order to release it from the retaining element 6. The release element 7 may be designed as a swivelable rocker, for example, which is automatically swiveled by the actuating force which the electrical conductor exerts on the release section 70, and which thus releases the clamping leg 44 from the retaining element 6 via the actuation section 71 that is moved along with same.

In other respects, the conductor connection terminal 1 according to FIGS. 7 and 8 has a design that is comparable to the conductor connection terminal according to FIGS. 5 and 6, in particular with regard to the actuation by the sliding actuating element 5.

The conductor connection terminal 1 with conductor clamping connections in the form of spring-loaded clamping connections has been explained with reference to the illustrations described above. The conductor connection terminal 1 may have, in whole or in part, conductor clamping connections in the form of insulation displacement connections 8, which may be situated in the housing in a similar way as for the clamping spring 4. By means of the actuating element 5, a displacement movement of the particular insulation displacement connection 8 and/or of the electrical conductor to be connected may be brought about, thus connecting the electrical conductor to the insulation displacement connection 8.

FIG. 10 shows an insulation displacement connection 8 of the conductor connection terminal 1. In this example, the insulation displacement connection 8 is designed as a bent metal part that is formed in one piece. The insulation displacement connection 8 has a base section 87 from which two separate neighboring arms 81, 82 branch off. In an insulation displacement area a cutting edge 83 is formed on each arm 81, 82, with a cutting gap 80 being formed between these oppositely situated cutting edges 83. Toward their free end, the cutting edges 83 terminate with a V-shaped cutting insertion section 84 extending at an angle to the cutting gap 80. An electrical conductor together with its insulation sheathing may be inserted into the cutting gap 80. Initially the insulation is separated between the V-shaped cutting insertion sections 84, and is exposed and clamped between the cutting edges 83 of the interior electrically conductive core of the electrical conductor.

The arms 81, 82 are separated from one another by a separating gap 85 situated therebetween. The separating gap 85 merges into the cutting gap 80. At the end area facing away from the cutting edges 83, the insulation displacement connection 8 has a connection contact 86, for example a pin contact, at the base body 87. The insulation displacement connection 8 may be fixed in the housing 2 by means of the connection contact 86 and/or the base body 87.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor connection terminal comprising:
a housing;
at least two conductor clamping connections to which at least one electrical conductor is connectable to a clamping point via an elastic force, the conductor clamping connections being arranged in the housing in a circular shape around a center; and
a sliding actuating element having a manual actuating surface to manually actuate multiple or all conductor clamping connections and/or the electrical conductor, the sliding actuating element being supported so that it is displaceable in the housing in a longitudinal displacement direction and/or the manual actuating surface of the sliding actuating element is arranged in a central area of the conductor connection terminal that is present between the conductor clamping connections.

2. The conductor connection terminal according to claim 1, wherein the longitudinal displacement direction of the sliding actuating element extends orthogonally to a plane defined by the circular shape of the conductor clamping connections.

3. The conductor connection terminal according to claim 1, wherein, by actuating the sliding actuating element at the manual actuating surface, the clamping points of conductor clamping connections are adapted to be opened, and/or a particular electrical conductor is adapted to be connected to the conductor clamping connections.

4. The conductor connection terminal according to claim 1, wherein, by actuating the sliding actuating element at the manual actuating surface, the particular conductor clamping connections and/or electrical conductors are adapted to be acted on with an actuating force in a radial direction and/or in an axial direction with respect to the circular shape of the conductor clamping connections.

5. The conductor connection terminal according to claim 1, wherein the sliding actuating element is nonrotatably supported in the housing.

6. The conductor connection terminal according to claim 1, wherein a conductor insertion opening for inserting an electrical conductor to be connected to the conductor clamping connection is associated with each conductor clamping connection.

7. The conductor connection terminal according to claim 1, wherein at least one actuating contour and/or at least one actuating element for actuating the particular conductor clamping connection and/or electrical conductor are arranged at a radial outer surface of the sliding actuating element.

8. The conductor connection terminal according to claim 7, wherein the actuating contour is designed as a ramp-shaped outer contour with at least one elevation and/or depression.

9. The conductor connection terminal according to claim 1, wherein one, multiple, or all conductor clamping connections are designed as spring-loaded clamping connections, each having at least one clamping spring and a busbar that is associated with the clamping spring, and which with the clamping spring forms a clamping point for connecting an electrical conductor.

10. The conductor connection terminal according to claim 9, wherein one, multiple, or all clamping springs have at least one clamping leg, a spring bend that adjoins the clamping leg, and a contact leg that adjoins the spring bend.

11. The conductor connection terminal according to claim 10, wherein the spring bend and/or the clamping leg protrude radially inwardly beyond the respective associated busbar.

12. The conductor connection terminal according to claim 10, wherein the clamping legs of the clamping springs are movable into an open position by actuating the sliding actuating element at the manual actuating surface, wherein for one, multiple, or all clamping springs the conductor connection terminal has a retaining element in each case which is configured to hold the clamping leg of the clamping spring in the open position.

13. The conductor connection terminal according to claim 12, wherein for one, multiple, or all of the retaining elements the conductor connection terminal has a release element that is associated with the retaining element and that has a release section via which the clamping leg that is held in the open position at the retaining element is releasable from the retaining element when an electrical conductor to be connected exerts an actuating force on the release section.

14. The conductor connection terminal according to claim 1, wherein one, multiple, or all conductor clamping connections are designed as insulation displacement connections, each having oppositely situated cutting edges between which a cutting gap is formed which establishes a clamping point for clamping an electrical conductor.

15. The conductor connection terminal according to claim 14, wherein the cutting gaps of multiple or all insulation displacement connections are oriented with regard to their longitudinal direction of extension in the radial direction and/or in the axial direction with respect to the circular shape in which the insulation displacement connections are arranged in the housing.

16. The conductor connection terminal according to claim 1, wherein at a conductor insertion side the conductor connection terminal has conductor insertion openings through which electrical conductors are adapted to be guided to the clamping points, and wherein, on a side facing away from the conductor insertion side, the conductor connection terminal has plug openings that lead to electrical plug contacts arranged in the housing of the conductor connection terminal.

17. An electrical plug connector or a circular plug connector, comprising at least one conductor connection terminal according to claim 1.
